(19) United States
(12) Patent Application Publication
(10) Pub. No.: US 2026/0138451 A1
(43) Pub. Date: May 21, 2026

(54) IDENTIFYING ARTIFICIAL INTELLIGENCE PERSONAS TO OPTIMALLY INFLUENCE DRIVING BEHAVIOR

(71) Applicant: TOYOTA RESEARCH INSTITUTE, INC., LOS ALTOS, CA (US)

(72) Inventors: JONATHAN A. DECASTRO, Arlington, MA (US); EMILY S. SUMNER, Cambridge, MA (US); DEEPAK EDAKKATTIL GOPINATH, Washington, DC (US); ANDREW M. SILVA, Cambridge, MA (US); THOMAS M. BALCH, Damariscotta, ME (US); XIONGYI CUI, Somerville, MA (US); GUY ROSMAN, Cambridge, MA (US)

(73) Assignees: TOYOTA RESEARCH INSTITUTE, INC., LOS ALTOS, CA (US); TOYOTA JIDOSHA KABUSHIKI KAISHA, TOYOTA-SHI (JP)

(21) Appl. No.: 18/955,720

(22) Filed: Nov. 21, 2024

(51) Int. Cl. B60K 35/28; B60K 35/26; B60W 50/14; G06T 13/40

(52) U.S. Cl. CPC B60K 35/28; B60K 35/265; B60W 50/14; G06T 13/40; B60K 2360/177; B60K 2360/1868; B60W 2050/146; B60W 2554/4046

(57) ABSTRACT

Systems and methods for identifying artificial intelligence (AI) personas to optimally influence driving behavior are provided. For example, a methodology of the presently disclosed technology may comprise: (1) determining a target driving behavior for a driver of a vehicle based on driving situation; (2) identifying a persona for an AI assistant with a highest predicted probability of influencing the driver to engage in the target driving behavior; and (3) using the AI assistant with the identified persona to present information to the driver to influence the driver to engage in the target driving behavior. In certain embodiments, identifying the persona for the AI assistant with the highest predicted probability of influencing the driver to engage in the target driving behavior may comprise determining the identified persona most reduces, among a plurality of personas, an objective function.

### Technical Field

The present disclosure relates generally to automotive systems and technologies. More particularly, some embodiments relate to identifying artificial intelligence (AI) personas to optimally influence driving behavior.

### DESCRIPTION OF RELATED ART

An artificial intelligence (AI) assistant may refer to a computer technology that utilizes generative AI to perform tasks, answer questions, carry out commands, etc.

Certain existing vehicle technologies utilize AI assistants to present information to drivers. In some cases, such information may be presented to influence a driver to perform a target/desired driving behavior (e.g., changing lanes or refraining from changing lanes, preparing to turn, slowing down, driving less aggressively, etc.).

### BRIEF SUMMARY OF THE DISCLOSURE

According to various embodiments of the disclosed technology, a system is provided. The system, in accordance with embodiments of the technology disclosed herein comprises:

In various embodiments, a method is provided. The method, in accordance with embodiments of the technology disclosed herein comprises:

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example vehicle, in accordance with various embodiments of the presently disclosed technology.

FIG. 2 illustrates an example process that can be performed to identify and deploy artificial intelligence (AI) personas to optimally influence driving behavior, in accordance with various embodiments of the presently disclosed technology.

FIG. 3 illustrates another example process that can be performed to identify and deploy AI personas to optimally influence driving behavior, in accordance with various embodiments of the presently disclosed technology.

FIG. 4 illustrates examples of AI personas, in accordance with various embodiments of the presently disclosed technology.

FIG. 5 illustrates additional examples of AI personas, in accordance with various embodiments of the presently disclosed technology.

FIG. 6 illustrates another example of AI personas, in accordance with various embodiments of the presently disclosed technology.

FIG. 7 is an example computing component that may be used to implement various features of embodiments described in the present disclosure.

The figures are not exhaustive and do not limit the present disclosure to the precise form disclosed.

### DETAILED DESCRIPTION

As described above, certain existing vehicle technologies utilize artificial intelligence (AI) assistants to present information to drivers. In some cases, such information (e.g., verbal instructions, audio-visual notifications, etc.) may be presented to influence a driver to perform a target/desired driving behavior (e.g., changing lanes or refraining from changing lanes, preparing to turn, slowing down, driving less aggressively, etc.).

Systems and methods of the presently disclosed technology improve on these existing technologies by identifying, and then deploying, a specific/optimal persona for an AI assistant (e.g., a stern persona, a friendly persona, a persona based on a family member of the driver, a persona based on an occupant of a nearby vehicle) predicted to most likely influence a driver to perform a target driving behavior. In other words, systems and methods can predict that the identified persona will exert the greatest social force (as compared to other available personas) on the driver to influence the target driving behavior. In this way, systems and methods can improve the likelihood of influencing a target driving behavior over existing/alternative technologies that utilize a single/generic persona for an AI assistant - or which otherwise fail to tailor/select personas for an AI assistant based on desired driving behavior or driving situation.

For example, a system of the presently disclosed technology may be configured to: (1) determine a target driving behavior for a driver of a vehicle based on driving situation; (2) identify a persona for an AI assistant with a highest predicted probability of influencing the driver to engage in the target driving behavior; and (3) use the AI assistant with the identified persona to present information to the driver to influence the driver to engage in the target driving behavior.

In various embodiments, systems and methods can identify an optimal persona for an AI assistant by minimizing an objective cost function. For example, systems and methods can identify a persona for the AI assistant with the highest predicted probability of influencing a driver to engage in a target driving behavior by determining the identified persona most reduces, among multiple available personas, the objective cost function. Here, a term of the objective cost function may reflect an impact (e.g., in terms of metrics such as safety and performance) of using the AI assistant with a respective persona on a predicted probability the driver will engage in the target driving behavior. Through this analysis and a subsequent deployment of the identified/optimal persona, systems and methods can improve the likelihood of influencing a target driving behavior over existing/alternative technologies that utilize a single/generic persona for an AI assistant. Moreover, systems and methods may improve/fine-tune cost function-based predictions of driver behavior by adding an additional cost function term - i.e., a term reflecting an impact of using a particular persona for an AI assistant presenting information to a driver.

In certain implementations, systems and methods may also identify a time interval to present information to a driver with a highest predicted probability of influencing the driver to engage in a target driving behavior. For example, the identified/optimal time interval may be a determined time before the target driving behavior (e.g., making a turn) is expected to take place, or after a determined time that a driver has engaged in an undesired driving behavior (e.g., driving aggressively, running one or more red lights, speeding, etc.). In this way, systems and methods can improve the likelihood of influencing a target driving behavior over existing/alternative technologies that fail to tailor (or otherwise consider) the timing of information presented by an AI assistant. Namely, as systems and methods are designed in appreciation of, the timing of information presentation can be as important/impactful as the content of the information itself.

Similar to identifying the optimal persona for an AI assistant, systems and methods can also use an objective cost function to identify an optimal time interval for presenting information to a driver. For example, systems and methods can determine the identified time interval (and identified persona), among multiple time intervals (and personas), most reduce an objective cost function. As discussed above, a first term of the objective cost function may reflect an impact of using the AI assistant with a respective persona on a predicted probability the driver will engage in the target driving behavior. Similarly, a second term of the objective cost function can reflect an impact of presenting the information within a respective time interval on a predicted probability the driver will engage in the target driving behavior. Through this analysis and a subsequent deployment of the identified/optimal persona in the identified/optimal time interval, systems and methods can improve the likelihood of influencing a target driving behavior over existing/alternative technologies that utilize a single/generic persona for an AI assistant and/or to fail to tailor (or otherwise consider) the timing of information delivered by an AI assistant. Moreover, systems and methods may improve/fine-tune cost function-based predictions of driver behavior by adding additional cost function terms—i.e., a first term reflecting an impact of using a particular persona for an AI assistant presenting information to a driver and a second term reflecting an impact of presenting the information within a particular time interval to the driver.

In various implementations, systems and methods can leverage augmented reality (AR) technology to present identified/optimal personas to a driver. For example, systems and methods can use an AR device (e.g., AR glasses worn by a driver) to display a visual avatar of an identified persona to the driver. For example, if the identified persona is a grandparent of the driver, systems and methods may use the AR device to display a visual avatar of the driver's grandparent to appear in a passenger seat of the vehicle. Relatedly, systems and methods may cause the visual avatar to present verbal information/instructions to the driver in a voice of the driver's grandparent.

In certain implementations, systems and methods can leverage machine learning/AI to learn which personas for the AI assistant are most likely to influence different driving behaviors. For example, systems and methods can use machine learning to analyze historical driving behaviors of a particular driver where different personas for an AI assistant have been used to present instruction/information to the driver. Accordingly, systems and methods may learn which personas are most likely to influence different driving behaviors for the particular driver. Relatedly, in some implementations systems and methods can leverage historical driving data from many drivers to learn which personas are most likely to influence different driving behaviors for the average driver.

In various implementations, systems and methods can create and then transfer AI personas from one vehicle to another. For example, a driver of a first vehicle may create an AI persona based on themselves or another frequent occupant of the first vehicle (e.g., a child of the driver) by uploading images/video and audio recordings of the driver/frequent occupant to a system of the presently disclosed technology. The system (which may be implemented in the first vehicle) can then use various techniques (e.g., stable diffusion, large language models (LLMs)) to create an AI persona based on the driver/frequent occupant of the first vehicle based on the uploaded image/video and audio recordings. For example, the system can apply a generative model to a photo of a driver's family member to have an AI persona based on the family member appear to speak a generated sentence (e.g. “your driving is starting to scare me”) that minimizes the cost function. Additionally, to further minimize the cost function, the system can modify the visual appearance of the AI person based on the family member to reflect the emotional state of being worried.

Accordingly, when the first vehicle is traveling on a road segment and detects a second vehicle driving unsafely (e.g., speeding, swerving in between lanes, etc.), the first vehicle may transfer the AI persona of the driver/frequent occupant of the first vehicle, to the second vehicle. The second vehicle may determine that an AI persona based on a person in a nearby vehicle (e.g., an occupant of the first vehicle) is most likely to influence a driver of the second vehicle to engage in a target driving behavior (e.g., slowing down, staying within their lane, etc.). Accordingly, the second vehicle may utilize the AI persona transferred from the second vehicle to present information to the driver of the first vehicle.

As another example, a system of presently disclosed technology may collect audio-visual recordings within a vehicle that capture conversations between a driver and other occupants of the vehicle (e.g., friends and family members of the driver). The system may then create one or more personas for an AI assistant based on these audio-visual recordings. For example, the system can create the personas based on voices (e.g., tonal quality, speaking cadence, language syntax, etc.) of the other occupants of the vehicle. The system may then learn which of these AI personas is most likely to influence different target driving behaviors for the driver and deploy the AI personas in accordance with this learning.

It may be appreciated that the presently disclosed systems and methods provide a specific, technical solution in the technical field of AI assistant technology. Namely, systems and methods improve AI assistant technologies by dynamically identifying, and then deploying, a specific/optimal persona for an AI assistant predicted to most likely influence a driver to perform a target driving behavior. In this way, systems and methods present a technical improvement over existing/alternative AI assistant technologies that utilize a single/generic persona—or which otherwise fail to tailor/select personas based on desired driving behavior or driving situation.

Systems and methods may also provide a specific, technical improvement to autonomous and assisted driving technologies. Namely, systems and methods may improve/fine-tune cost function-based predictions of driver behavior by adding additional cost function terms—e.g., a first term reflecting an impact of using a particular persona for an AI assistant delivering information to a driver and a second term reflecting an impact of presenting the information within a particular time interval to the driver. Predicting driver behavior can be a critical computation for autonomous and assisted driving technologies. Accordingly, by facilitating improved/fine-tuned cost function-based predictions of driver behavior, systems and methods provide a specific, technical improvement to autonomous and assisted driving technologies as well.

The systems and methods disclosed herein may be implemented with any of a number of different vehicles and vehicle types. For example, the systems and methods disclosed herein may be used with automobiles, trucks, motorcycles, recreational vehicles and other types of vehicles. In addition, the principles disclosed herein may be utilized by systems that are external from vehicles (e.g., cloud-based systems).

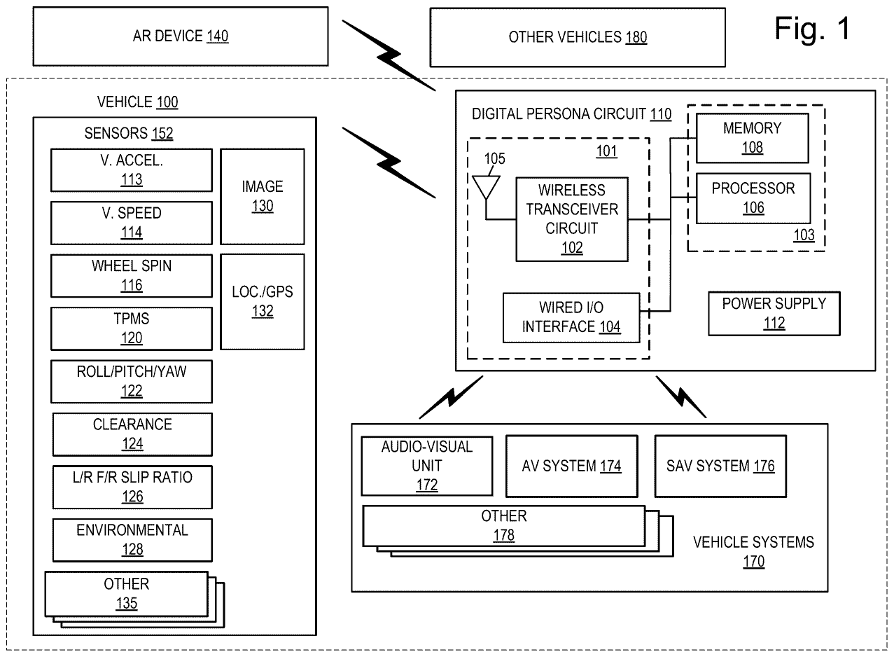

FIG. 1 illustrates an example vehicle 100, in accordance with various embodiments of the presently disclosed technology.

Before describing individual components of vehicle 100 in more detail, a high-level operational overview may be useful.

In certain embodiments, vehicle 100 (or more specifically digital persona circuit 110) can determine a target driving behavior for a driver of vehicle 100 based on driving situation. Vehicle 100 may make this determination based on information obtained from at least one of sensors 152, an autonomous vehicle (AV) system 174, and a semi-autonomous vehicle (SAV) system 176.

Vehicle 100 (or more specifically digital persona circuit 110) can then identify a (digital) persona for an AI assistant with a highest predicted probability of influencing the driver to engage in the target driving behavior. The identified persona may be one of multiple available digital personas stored in memory 108. As described above, in some implementations vehicle 100 (or more specifically digital persona circuit 110) may create one or more of these digital personas based on audio-visual recordings within vehicle 100 or information obtained from other vehicles 180 (e.g., digital personas based on images and/or voice recordings of occupants of other vehicles 180). In certain implementations, vehicle 100 (or more specifically digital persona circuit 110) may receive the digital personas themselves from other vehicles 180.

Vehicle 100 (or more specifically digital persona circuit 110) can then use the AI assistant with the identified persona to present information to the driver to influence the driver to engage in the target driving behavior. In some implementations, this may comprise presenting/displaying the identified persona via audio-visual unit 172. In other implementations, this may comprise causing augmented reality (AR) device 140 (e.g., an AR headset, AR glasses, etc.) to present/display the identified persona to the driver of vehicle 100.

Referring now to vehicle 100 and FIG. 1 in more detail, as depicted, vehicle 100 comprises a digital persona circuit 110, sensors 152, and vehicle systems 170. Sensors 152 and vehicle systems 170 can communicate with digital persona circuit 110 via a wired or wireless communication interface. Although sensors 152 and vehicle systems 170 are depicted as communicating with digital persona circuit 110, they can also communicate with each other. Digital persona circuit 110 can be implemented as an electronic control unit (ECU) or as part of an ECU. In other embodiments, digital persona circuit 110 can be implemented independently of an ECU.

In the specific example of FIG. 1, digital persona circuit 110 includes a communication circuit 101, a decision circuit 103 (including a processor 106 and a memory 108), and a power supply 112. Components of digital persona circuit 110 are illustrated as communicating with each other via a data bus, although other interfaces can be included.

Processor 106 can include one or more general processing units (GPUs), central processing units (CPUs), microprocessors, or any other suitable processing system. Processor 106 may include a single core processor or multicore processors. Memory 108 may include one or more various forms of memory or data storage (e.g., flash, RAM, etc.) that may be used to store digital personas, cost function terms/parameters for predicting driver behavior, machine learning model parameters, calibration parameters, images (analysis or historic), point parameters, instructions and variables for processor 106 as well as any other suitable information. Memory 108 can be made up of one or more modules of one or more different types of memory and may be configured to store data and other information as well as operational instructions that may be used by processor 106.

Although the example of FIG. 1 is illustrated using processor and memory circuitry, in various embodiments decision circuit 103 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up digital persona circuit 110.

Communication circuit 101 can utilize a wireless transceiver circuit 102 with an associated antenna 105 for wireless communication. Communication circuit 101 can also utilize a wired I/O interface 104 with an associated hardwired data port (not illustrated). As this example illustrates, communications with digital persona circuit 110 can include either or both wired and wireless communications. Wireless transceiver circuit 102 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 105 is coupled to wireless transceiver circuit 102 and is used by wireless transceiver circuit 102 to transmit radio signals wirelessly to wireless equipment and to receive radio signals as well. These radio signals can include information of almost any sort that is sent or received by digital persona circuit 110 to/from other entities such as sensors 152, vehicle systems 170, AR device 140, and other vehicles 180.

Wired I/O interface 104 can include a transmitter and a receiver (not shown) for hardwired communications with other devices. For example, wired I/O interface 104 can provide a hardwired interface to other components, including sensors 152 and vehicle systems 170. Wired I/O interface 104 can communicate with other devices using Ethernet or any of a number of other wired communication protocols whether standardized, proprietary, open, point-to-point, networked or otherwise.

Power supply 112 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, vehicle acceleration sensors 113, vehicle speed sensors 114, wheelspin sensors 116 (e.g., one for each wheel), a tire pressure monitoring system (TPMS) 120, accelerometers such as a 3-axis accelerometer 122 to detect roll, pitch and yaw of the vehicle, vehicle clearance sensors 124, left-right and front-rear slip ratio sensors 126, environmental sensors 128 (e.g., to detect salinity or other environmental conditions), image sensor(s) 130, and location sensor(s) 132. Other sensors 135 can also be included as may be appropriate for a given implementation of vehicle 100. For example, other sensors 135 may include gyroscopes, odometers, etc. Other sensors 135 may also include audio sensors configured to capture voices of occupants inside vehicle 100.

In some embodiments, image sensor(s) 130 may comprise one or more cameras configured to generate image data of an environment surrounding or within vehicle 100. The image data may comprise images of the environment, including of persons inside vehicle 100 and of persons in vehicles proximate vehicle 100 on a road segment.

In certain embodiments, location sensor(s) 132 may comprise a global navigation satellite sensor, a global position sensor, or other types of vehicle positioning sensors. Location sensor(s) 132 may be configured to generate location data for vehicle 100 and/or location data for landmarks in the environment surrounding vehicle 100. The location data may comprise precise coordinates (e.g., latitude, longitude, and altitude) of vehicle 100's position or the position(s) of landmark(s) on the Earth's surface.

In some embodiments, one or more of sensors 152 may include their own processing capability to compute the results for additional information that can be provided to digital persona circuit 110. In other embodiments, one or more of sensors 152 may be data-gathering-only sensors that only provide raw data to digital persona circuit 110. In further embodiments, one or more hybrid sensors may be included that provide a combination of raw data and processed data to digital persona circuit 110. Sensors 152 may provide analog outputs, digital outputs, or a combination of both.

Vehicle systems 170 can include any of a number of different vehicle components or subsystems used to control or monitor various aspects of vehicle 100 and its performance. For example, vehicle systems 170 may include any one or combination of an audio-visual unit 172, an autonomous vehicle (AV) system 174, a semi-autonomous vehicle (SAV) system 176, and other vehicle systems 178.

As described above, audio-visual unit 172 may be used to present AI assistant personas to a driver of vehicle 100. In certain examples audio-visual unit 172 may be implemented as part of an in-vehicle infotainment (IVI) system (IVI systems may deliver entertainment and information to occupants of a vehicle through audio/video interfaces, control elements like touch screen displays, button panels, voice commands, etc.). In certain examples audio-visual unit 172 may be a liquid crystal display (LCD) screen. In various examples, audio-visual unit 172 may comprise multiple displays/screens, e.g., a dashboard display, a heads-up display, etc.

In general, AV and SAV systems (e.g., AV system 174 and SAV system 176) can control driving behaviors of a vehicle. AV and SAV systems can interpret sensory information, identify appropriate traffic configurations, determine vehicle navigation paths, and actuate vehicle systems in accordance with determined vehicle navigation paths. Many AV and SAV systems are directed systems that minimize vehicle collisions.

As described above, digital persona circuit 110 can use information from AV system 174 and SAV system 176 to determine a target driving behavior based on driving situation. Namely, existing AV and SAV systems are well known for being able to determine desired/optimal driving behavior based on sensor data, analysis of past driving behavior, etc.

As alluded to above, systems and methods can also provide a specific, technical improvement to autonomous and assisted driving technologies (e.g., AV system 174 and SAV system 176). Namely, systems and methods may improve/fine-tune cost function-based predictions of driver behavior by adding additional cost function terms—e.g., a first term reflecting an impact of using a particular persona for an AI assistant delivering information to a driver and a second term reflecting an impact of presenting the information within a particular time interval to the driver. Predicting driver behavior can be a critical computation for autonomous and assisted driving technologies. Accordingly, by facilitating improved/fine-tuned cost function-based predictions of driver behavior, systems and methods provide a specific, technical improvement to autonomous and assisted driving technologies (e.g., AV system 174 and SAV system 176) as well.

As described above, AR device 140 may comprise various types of AR devices including AR glasses, an AR headset, a projector/head-up display that projects AR images onto a windshield of a vehicle, etc. In certain implementations, AR device 140 may be one of vehicle systems 170. In other implementations, AR device 140 may be implemented independently from vehicle 100. In such implementations, AR device 140 can communicate with vehicle 100/digital persona circuit 110 via wired or wireless communication as described above.

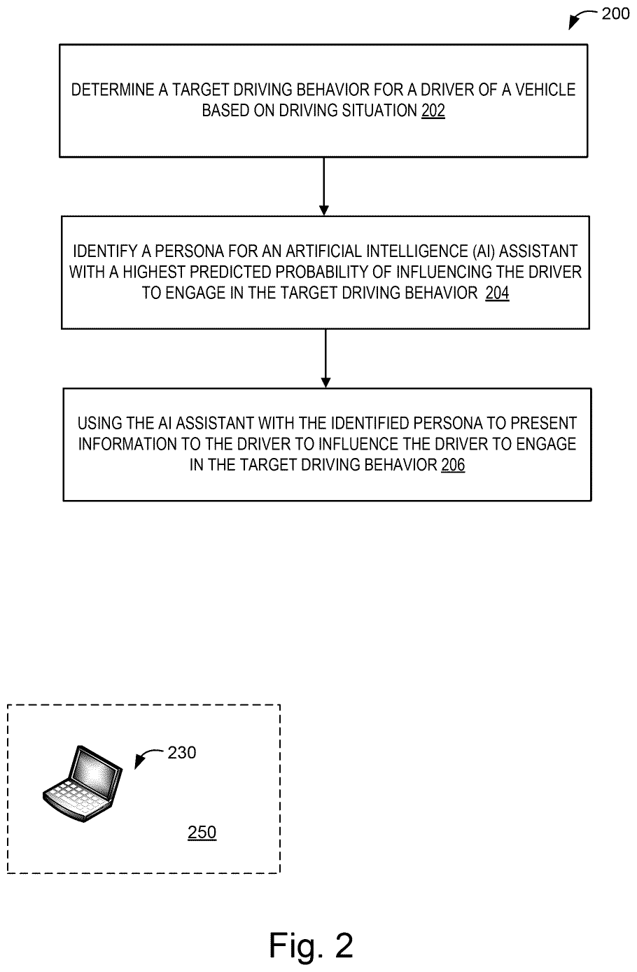

FIG. 2 illustrates an example process 200 that can be performed by a system 230 to identify and deploy AI personas to optimally influence driving behavior, in accordance with various embodiments of the presently disclosed technology. In some embodiments, system 230 may be implemented in a vehicle 250. Vehicle 250 may be the same/similar vehicle as vehicle 100 described in conjunction with FIG. 1.

As depicted, system 230 can perform operation 202 to determine a target driving behavior for a driver of vehicle 250 based on driving situation. System 230 can leverage a combination of sensor data from vehicle 250 and an on-board AV or SAV system of vehicle 250 to make this determination. As discussed above, existing AV and SAV systems are well known for being able to determine desired/optimal driving behavior based on sensor data, analysis of past driving behavior, etc.

System 230 can then perform operation 204 to identify a persona for an AI assistant with a highest predicted probability of influencing the driver to engage in the target driving behavior. In certain cases, the identified persona may be based on a specific person (e.g., an acquaintance of the driver such as a friend of family member of the driver, an occupant of a nearby vehicle, etc.). In other cases, the identified persona may be based on an amalgamation of multiple persons, or may reflect a more generalized type of person, personality type, or mood (e.g., a stern authority figure, a chatty friend, a concerned child, etc.).

In various implementations, the identified persona may reflect a verbal persona, a visual persona (e.g., a visual avatar), or a combination of verbal and visual personas.

As discussed above, in some implementations system 230 can leverage machine learning/AI to learn which personas for the AI assistant are most likely to influence different driving behaviors. For example, system 230 can use machine learning to analyze historical driving behaviors of the driver of vehicle 250 where different personas for the AI assistant have been used to present instruction/information to the driver. Accordingly, system 230 may learn which personas are most likely to influence different driving behaviors for the driver. Relatedly, in some implementations system 230 can leverage historical driving data from many drivers to learn which personas are most likely to influence different driving behaviors for the average driver.

In various implementations, system 230 can create and then transfer AI personas to other vehicles, or receive AI personas from other vehicles. For example, a driver of a second vehicle may create an AI persona based on themselves or another frequent occupant of the second vehicle (e.g., a child of the driver) by uploading images/video and audio recordings of the driver/frequent occupant to system 230 or another system in communication with system 230. The uploading system (e.g., system 230 or the system in communication with system 230) can then use various techniques (e.g., stable diffusion, large language models (LLMs)) to create an AI persona based on the driver/frequent occupant of the second vehicle based on the uploaded image/video and audio recordings. Accordingly, when the second vehicle is traveling on a road segment and detects vehicle 250 driving unsafely (e.g., speeding, swerving in between lanes, etc.), the second vehicle may transfer the AI persona of the driver/frequent occupant of the second vehicle, to vehicle 250/system 230. System 230 may determine that an AI persona based on a person in a nearby vehicle (e.g., an occupant of the second vehicle) is most likely to influence the driver of vehicle 250 to engage in a target driving behavior (e.g., slowing down, staying within their lane, etc.). Accordingly, system 230 may identify the AI persona transferred from the second vehicle as the persona most likely to influence the driver to engage in the target driving behavior.

As another example, system 230 may collect audio-visual recordings within vehicle 250 that capture conversations between the driver and other occupants of vehicle 250 (e.g., friends and family members of the driver). System 230 may then create one or more personas for the AI assistant based on these audio-visual recordings. For example, system 250 can create the personas based on voices (e.g., tonal quality, speaking cadence, language syntax, etc.) of the other occupants of vehicle 250. System 230 may then learn which of these AI personas is most likely to influence different target driving behaviors for the driver, and identify optimal personas for the AI assistant (based on targeted driving behavior, driving situation, etc.) in accordance with this learning.

As discussed above, in certain implementations system 230 can identify the persona for the AI assistant with the highest predicted probability of influencing the driver to engage in the target driving behavior by determining the identified persona most reduces, among a plurality of personas, an objective function. Here, a term of the objective cost function may reflect an impact of using the AI assistant with a respective persona of the plurality of personas on a predicted probability the driver will engage in the target driving behavior.

As discussed above, in some implementations system 230 can also identify a time interval for the AI assistant with the identified persona to present the information to the driver with a highest predicted probability of influencing the driver to engage in the target driving behavior. Similar to identifying the optimal persona, system 230 can identify an optimal time interval by reducing an objective cost function. For example, system 230 can determine the identified time interval and identified persona, among a plurality of time intervals and personas, most reduce an objective function. As discussed above, a first term of the objective cost function may reflect an impact of using the AI assistant with a respective persona of the plurality of personas on a predicted probability the driver will engage in the target driving behavior. Relatedly, a second term of the objective cost function may reflect an impact of presenting the information within a respective time interval of the plurality of time intervals on a predicted probability the driver will engage in the target driving behavior.

As depicted, system 230 can perform operation 206 to use the AI assistant with the identified persona to present information (e.g., instructions, suggestions, etc.) to the driver to influence the driver to engage in the target driving behavior. In embodiments where system 230 has also identified (an optimal) time interval to present the information, system 230 can use the AI assistant with the identified persona to present the information to the driver in the identified time interval.

In certain implementations, system 230 can use AR device (e.g., AR Device 140 from FIG. 1) to display, to the driver, a visual avatar of the identified persona. For example, where the identified persona is an acquaintance of the driver (e.g., a friend or family member of the driver), system 230 can use the AR device to display a visual avatar of the acquaintance to appear in a passenger seat of vehicle 250. Relatedly, system 250 can present the information using gestures of the visual avatar, a speaking voice of the acquaintance, or a combination of gestures and the speaking voice of the acquaintance.

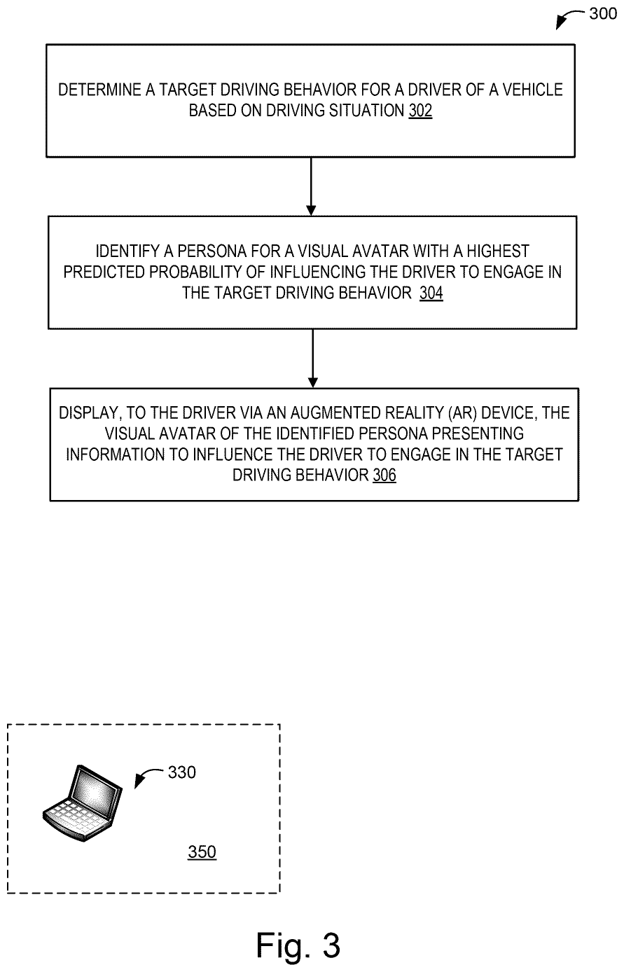

FIG. 3 illustrates an example process 300 that can be performed by a system 330 to identify and deploy AI personas to optimally influence driving behavior, in accordance with various embodiments of the presently disclosed technology. In some embodiments, system 330 may be implemented in a vehicle 350. Vehicle 350 may be the same/similar vehicle as vehicle 100 described in conjunction with FIG. 1.

As depicted, system 330 can perform operation 302 to determine a target driving behavior for a driver of vehicle 350 based on driving situation. System 330 can perform this operation in the same/similar manner as described in conjunction with operation 202 of FIG. 2.

System 330 can them perform operation 304 to identify a persona for a visual avatar with a highest predicted probability of influencing the driver to engage in the target driving behavior. System 330 can perform this operation in the same/similar manner as described in conjunction with operation 204 of FIG. 2.

System 330 can them perform operation 306 to display, to the driver via AR device, the visual avatar of the identified persona presenting information to influence the driver to engage in the target driving behavior. System 330 can perform this operation in the same/similar manner as described in conjunction with operation 206 of FIG. 2.

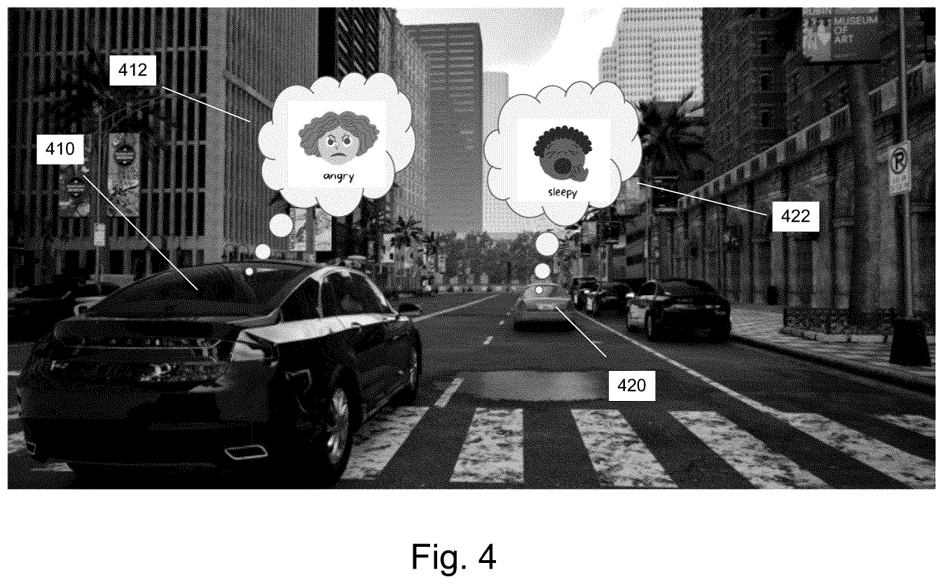

FIG. 4 illustrates examples of AI personas, in accordance with various embodiments of the presently disclosed technology.

As depicted, an AI persona 412 may be implemented in a vehicle 410. Likewise, an AI persona 422 may be implemented in a vehicle 420.

AI persona 412 may be, for example, based on a family member of the driver of vehicle 410. As depicted, AI persona 412 may also have an angry emotional state. As alluded to above, a system of the presently disclosed technology may have selected AI persona 412 (including the angry emotional state for AI persona 412) to influence a driver of vehicle 410 to engage in a target driving behavior.

AI persona 422 may, for example, be based on an occupant (e.g., a young child passenger) of vehicle 410 (here vehicle 410 may have transferred AI persona 422 to vehicle 420 as vehicle 410 and vehicle 420 travel together on the road). As depicted, AI persona 422 may also have a sleepy emotional/cognitive state. As alluded to above, a system of the presently disclosed technology may have selected AI persona 422 (including the sleepy emotional/cognitive state for AI persona 422) to influence a driver of vehicle 420 to engage in a target driving behavior.

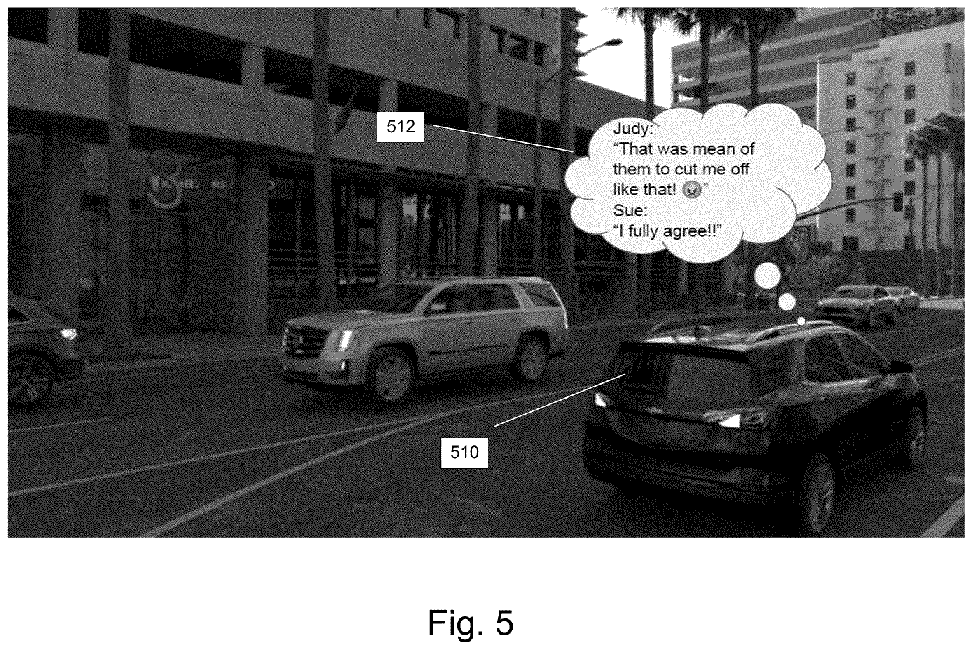

FIG. 5 illustrates additional examples of AI personas, in accordance with various embodiments of the presently disclosed technology.

As depicted, two AI personas (i.e., Judy and Sue) may be implemented in a vehicle 510. A system of the presently disclosed technology may apply a generative language model to the two AI personas to generate a conversation 512 between the two personas commenting on a particular driving situation. As alluded to above, a system of the presently disclosed technology may have the two AI personas and generated their conversation to influence a driver of vehicle 510 to engage in a target driving behavior.

In certain examples, Judy may be an actual (i.e., non-AI persona) driver of vehicle 510, and Sue may be an AI persona. Accordingly, the system can apply a generative language model to engage in conversation 512 with Judy. Sue's tone and choice of words may be selected by the system to influence Judy to engage in a target driving behavior.

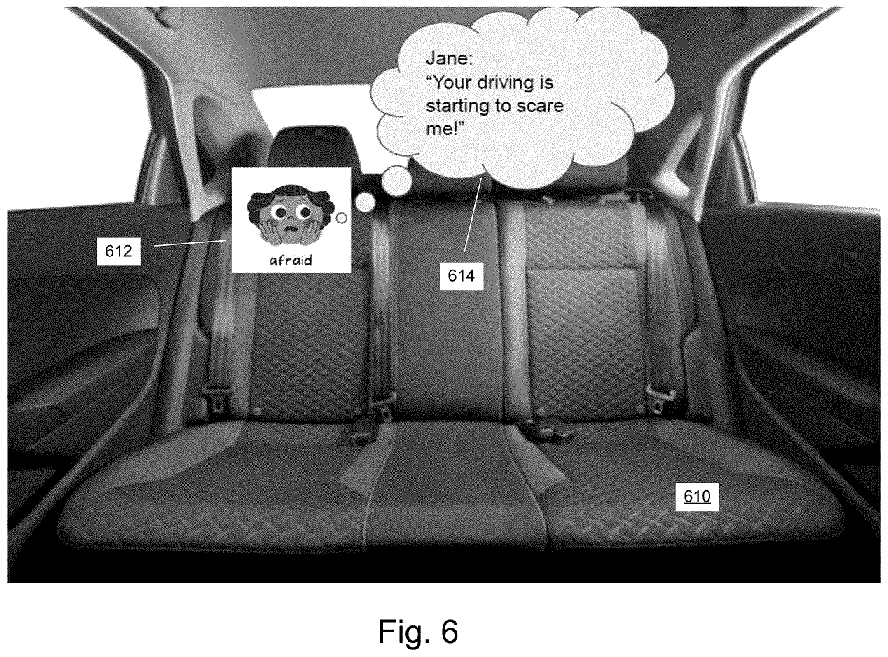

FIG. 6 illustrates another example of AI personas, in accordance with various embodiments of the presently disclosed technology.

As depicted, an AI persona 612 may be implemented in a vehicle 610. In certain implementations, a visual avatar of AI persona 612 may be made to appear in a backseat of vehicle 610.

AI persona 612 may be based on a young child in a vehicle proximate vehicle 610. A system of the presently disclosed technology can also use a generative model to have AI persona 612 converse with a driver of vehicle 610 via conversation 614.

As alluded to above, a system of the presently disclosed technology may have selected AI persona 612 and conversation 614 to influence the driver of vehicle 610 to engage in a target driving behavior.

As used herein, the terms circuit and component might describe a given unit of functionality that can be performed in accordance with one or more embodiments of the present application.

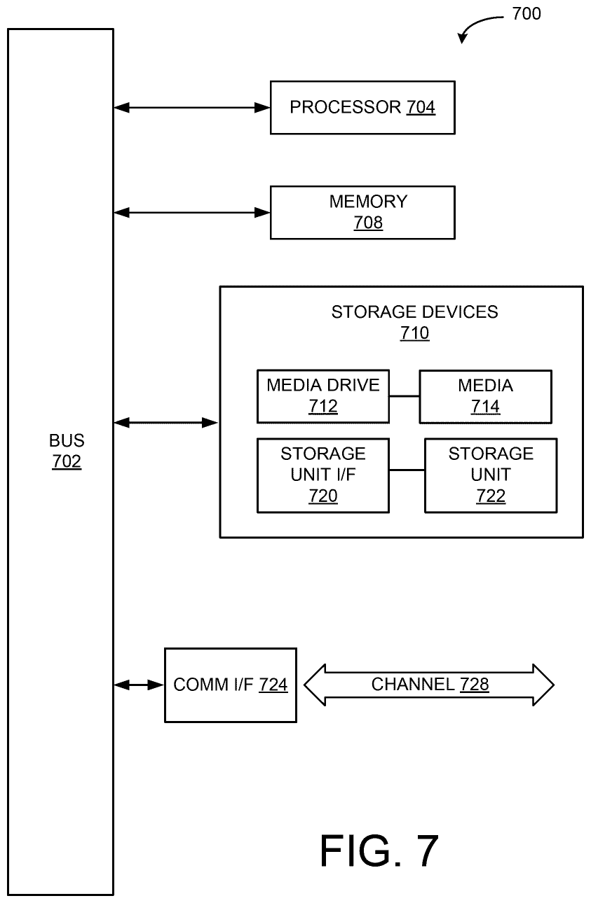

As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that such features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. This can include a processor, and/or any one or more of the components making up a user device, a user system, and a non-decrypting cloud service. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communication interfaces. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
an augmented reality (AR) device;
one or more processing resources; and
non-transitory computer-readable medium, coupled to the one or more processing resources, comprising stored instructions that when executed by the one or more processing resources, cause the system to:
determine a target driving behavior for a driver of a vehicle based on driving situation;
identify a persona for a visual avatar with a highest predicted probability of influencing the driver to engage in the target driving behavior; and
display, to the driver via the AR device, the visual avatar of the identified persona presenting information to influence the driver to engage in the target driving behavior.

2. The system of claim 1, wherein:
identifying the persona for the visual avatar with the highest predicted probability of influencing the driver to engage in the target driving behavior comprises determining the identified persona most reduces, among a plurality of personas, an objective function; and
a term of the objective cost function reflects an impact of displaying a visual avatar of a respective persona of the plurality of personas on a predicted probability the driver will engage in the target driving behavior.

3. The system of claim 1, wherein the identified persona comprises:
an acquaintance of the driver; or
a person in a second vehicle proximate the vehicle in a traffic segment.

4. The system of claim 3, wherein displaying the visual avatar of the identified persona presenting the information to the driver comprises displaying the visual avatar of the identified persona presenting the information in a speaking voice of:
the acquaintance; or
the person in the second vehicle.

5. The system of claim 1, wherein displaying the visual avatar of the identified persona comprises displaying the visual avatar of the identified persona to appear in a passenger seat of the vehicle.

6. A method comprising:
determining a target driving behavior for a driver of a vehicle based on driving situation;
identifying a persona for an artificial intelligence (AI) assistant with a highest predicted probability of influencing the driver to engage in the target driving behavior; and
using the AI assistant with the identified persona to present information to the driver to influence the driver to engage in the target driving behavior.

7. The method of claim 6, wherein:
identifying the persona for the AI assistant with the highest predicted probability of influencing the driver to engage in the target driving behavior comprises determining the identified persona most reduces, among a plurality of personas, an objective function; and
a term of the objective cost function reflects an impact of using the AI assistant with a respective persona of the plurality of personas on a predicted probability the driver will engage in the target driving behavior.

8. The method of claim 6, wherein the identified persona comprises at least one of a visual persona and a voice persona.

9. The method of claim 8, wherein the visual persona comprises a visual avatar of:
an acquaintance of the driver; or
a person in a second vehicle proximate the vehicle in a traffic segment.

10. The method of claim 8, wherein the voice persona comprises a voice of:
an acquaintance of the driver; or
a person in a second vehicle proximate the vehicle in a traffic segment.

11. The method of claim 8, wherein using the AI assistant with the identified persona to present the information to the driver comprises using an augmented reality (AR) device to display, to the driver, the visual avatar of:
the acquaintance speaking in a voice of the acquaintance; or
the person in the second vehicle speaking in a voice of the person in the second vehicle.

12. The method of claim 11, wherein using the AR device to display the visual avatar to the driver comprises:
using the AR device to display the visual avatar to appear in a passenger seat of the vehicle.

13. The method of claim 6, further comprising:
identifying a time interval for the AI assistant with the identified persona to present the information to the driver with a highest predicted probability of influencing the driver to engage in the target driving behavior;
wherein using the AI assistant with the identified persona to present the information to the driver comprises using the AI assistant with the identified persona to present the information to the driver in the identified time interval.

14. The method of claim 13, wherein:
identifying the time interval for the AI assistant with the identified persona to present the information to the driver with the highest predicted probability of influencing the driver to engage in the target driving behavior comprises determining the identified time interval and identified persona, among a plurality of time intervals and personas, most reduce an objective function;
a first term of the objective cost function reflects an impact of using the AI assistant with a respective persona of the plurality of personas on a predicted probability the driver will engage in the target driving behavior; and
a second term of the objective cost function reflects an impact of presenting the information within a respective time interval of the plurality of time intervals on a predicted probability the driver will engage in the target driving behavior.

15. A vehicle comprising:
one or more processing resources; and
non-transitory computer-readable medium, coupled to the one or more processing resources, comprising stored instructions that when executed by the one or more processing resources, cause the vehicle to:
determine a target driving behavior for a driver of the vehicle based on driving situation;
identify a persona for an artificial intelligence (AI) assistant with a highest predicted probability of influencing the driver to engage in the target driving behavior; and
using the AI assistant with the identified persona to present information to the driver to influence the driver to engage in the target driving behavior.

16. The vehicle of claim 15, wherein:
identifying the persona for the AI assistant with the highest predicted probability of influencing the driver to engage in the target driving behavior comprises determining the identified persona most reduces, among a plurality of personas, an objective function; and
a term of the objective cost function reflects an impact of using the AI assistant with a respective persona of the plurality of personas on a predicted probability the driver will engage in the target driving behavior.

17. The vehicle of claim 15, wherein the identified persona comprises at least one of a visual persona and a voice persona.

18. The vehicle of claim 17, wherein the visual persona comprises a visual avatar of:
an acquaintance of the driver; or
a person in a second vehicle proximate the vehicle in a traffic segment.

19. The vehicle of claim 17, wherein the voice persona comprises a voice of:
an acquaintance of the driver; or
a person in a second vehicle proximate the vehicle in a traffic segment.

20. The vehicle of claim 17, wherein using the AI assistant with the identified persona to present the information to the driver comprises using an augmented reality (AR) device to display, to the driver, the visual avatar of:
the acquaintance speaking in a voice of the acquaintance; or
the person in the second vehicle speaking in a voice of the person in the second vehicle.
